(19) United States
(12) Patent Application Publication
(10) Pub. No.: US 2005/0220676 A1
(43) Pub. Date: Oct. 6, 2005

(54) Multi-range pipette

(76) Inventor: Nathaniel Tue Tran, Irvine, CA (US)

Correspondence Address: NATHANIEL TUE TRAN, 3205 ASPEN GROVE, IRVINE, CA, 92618, US

(21) Appl. No.: 11/098,917

(22) Filed: Apr. 4, 2005

Related U.S. Application Data
(60) Provisional application No. 60/559,684, filed on Apr. 2, 2004.

(51) Int. Cl. B01L 3/02

(52) U.S. Cl. 422/100

(57) ABSTRACT

A pipette with multiple ranges capable of replacing at least two pipettes of different ranges is described. The pipette has multiple cylinders and pistons for the different ranges and the ranges are conveniently selected by simply choosing the corresponding snap-on disposable tip. The pipette comprises of at least two cylinders and pistons of different sizes to accommodated two different sizes snap-on tips while sharing all other mechanisms including volume setting, plunger, and ejection mechanism. A modified disposable tip for the lower range is also described to accommodate normal tip ejection.

### CROSS REFERENCE TO RELATED APPLICATION

This application claims priority of provisional application U.S. Ser. No. 60/559684 filed Apr. 2, 2004 titled Multi-range Pipette.

### BACKGROUND OF THE INVENTION

This invention relates to syringe-type pipettes, and more particularly to a micro-dispensing positive displacement pipette of the type employing a snap-on precision disposable dispensing tip and having a dispensing plunger whose retracted intake position may be adjusted to provide an accurately preset delivery volume.

Pipettes' can maintain good precision to as low as about 10-20% of the highest volume the pipette can deliver. For example, if a pipette can deliver up to 1000 ul, then it is recommended for use to deliver volume between 100 ul (preferably 200 ul) and 1000 ul. Using the pipette to deliver volume below 100 ul will suffers high degree of inaccuracy. As a result, one needs at least three different pipettes to cover volume from 1 ul to 1000 ul: a P-10 (0-10 ul), a P-100 (0-100 ul), and a P-1000 (0-1000 ul).

Existing pipettes are made with different ranges such as 0-2 ul, 0-10 ul, 0-20 ul, 0-100 ul, 0-200 ul, 0-1000 ul, and 0-10,000 ul. There are also some made in less popular ranges besides those mentioned previously. Either way, pipetting different volumes generally requires more than one pipette which may introduce some inconveniences to the user especially in tight spaces.

### SUMMARY OF THE INVENTION

Briefly, the invention describes a method and novel design to enable the combination of a plurality of pipettes with different ranges all into one unit. The pipette is capable of accommodating various sizes snap-on tips to allow dispensing different volume of liquid. The pipette has one plunger, one readout just like existing pipettes, but has more than one range. To select a range to use, the user simply selects the appropriate snap-on tip.

One preferred embodiment is a pipette comprises of one or more cylinders within the main cylinder as illustrated in FIG. 1. Each has its own piston for air displacement. The pistons from various cylinders are interconnected so that they all travel in unison. The different cylinders are designed with cross-section area ratio corresponding to the ratio between various ranges. The different cylinders (or range of the pipette) are selected by the user by using the corresponding pipette tips. For instance, the user can pick up a P-10 tip to use the 0-10 ul range or pick up a P-1000 tip to use the 0-1000 ul range.

An alternative design is a pipette comprises of at least two cylinders adjacent to each other as in multi-pipette but with different ranges and can also accommodate different size pipette tips. The cylinders can be arranged in any format that is practical and convenient for the operator. For example, three cylinders are generally arranged in a triangular format.

The preferred ranges used in combination are in multiple of 10 times each others such as 0-10, 0-100, and 0-1000. The digital readout will commonly display the number of the biggest range leaving the operator to interpret the correct volume corresponding with the range use. Additionally, color-coding aids such as matching the color of the decimal point and or last digit with the color of the tip-rack use is also helpful.

Alternatively, for the electronic version, other variable ranges are possible in combination with tip sensing. For instance, when a range of 0-1000 ul and a range of 0-250 ul are used together, the display will show the appropriate number for the pipette cylinder used base on which tip is detected.

### BRIEF DESCRIPTION OF THE DRAWINGS

FIG. 1 is a representation of the two-cylinder part of a pipette where one cylinder is partially enclosed within the other cylinder. A modified version of a smaller pipette tip to accommodate tip ejection in this multi-range pipette is also illustrated.

### DETAIL DESCRIPTION OF THE INVENTION

Laboratory micro-pipettes are commonly used to measure small volumes of liquid. There are currently two different types: single channel and multi-channel pipettes. Single channel pipette picks up one pipette tip and dispense one volume at a time. Multi-channel pipette dispenses similar volumes in multiple channels at a time. Advantages for multi-channel pipette include less work for filling multiple wells in a plate such as 96-well plate. Additionally, the reproducibility (precision) between the wells is also improved.

Inventive Step:

The multi-range pipette in this invention has multiple cylinders and pistons for air displacement. The difference compared to multi-channel pipette is that the cylinders are made to have different sizes and may also fit different pipette tips. The different sizes cylinders resulting in different volumes dispensed with the same movement of the plunger. The different ranges cylinders can be arranged so that they are adjacent to each other or within each other.

For convenience, the prefer ranges are made to be 10 times of each others. A pipette can have the range of 0 to 1000 μl and 0 to 100 μl and if possible also 0 to 10 μl. The digital readout will read from 0 to 1000; however, the dispensing volume is depending on which pipette tip the operator uses. For instance, the above pipette can pick up a P-1000 tip and use the range of 0-1000 ul (where volume more than 100 ul is recommended for high precision and accuracy). The same pipette can also pick up a P-100 tip and use the 0-100 ul range (where volume more than 10 ul, but less than 100 ul is recommended) or pick up a P-10 tip to use the range of 0-10 ul (where volume of 10 ul or less is required). The digital readout and or last digit can be color coded to facilitate volume reading. For instance, a blue decimal point and or a blue fourth digit from zero to nine for the range using tips from a blue box (0-1000 ul for rainin's pipette), and a red decimal point for the range using tips from a red box, thus the readout is read as 1000 with the blue decimal point, but 10.00 with the red decimal point.

Additional Features:

For electronic pipettes, there is more flexibility regarding the different ranges such as automatic detection of which tip is in used to display the decimal point in the right position when ranges in multiple of 10 are used together. Additionally, added designs can also make it possible to pick up just one type of tip but not other type when the pipette is set a certain way. For instance, if the operator dials 10 ul then the pipette only allow picking up the P-10 pipette tip or will sound an alarm if some other tips are picked up. Such automatic designs also enable the use of ranges that are not multiple of 10 of each others without causing any confusion to the operator.

For instance, an electronic pipette design can have an operator pick up a pipette tip and then dial a volume. If the volume is not within the working range of the tip, then an error message is given. Alternatively, the operator can also dial a volume and then pick up a pipette tip. If the wrong tip is picked up, either an alarm will sound, or the pipette won't pickup and dispense or both. One such electronic pipette can easily cover volume from 1 micro liter to 2000 micro liter with high precision using three different tips.

Design:

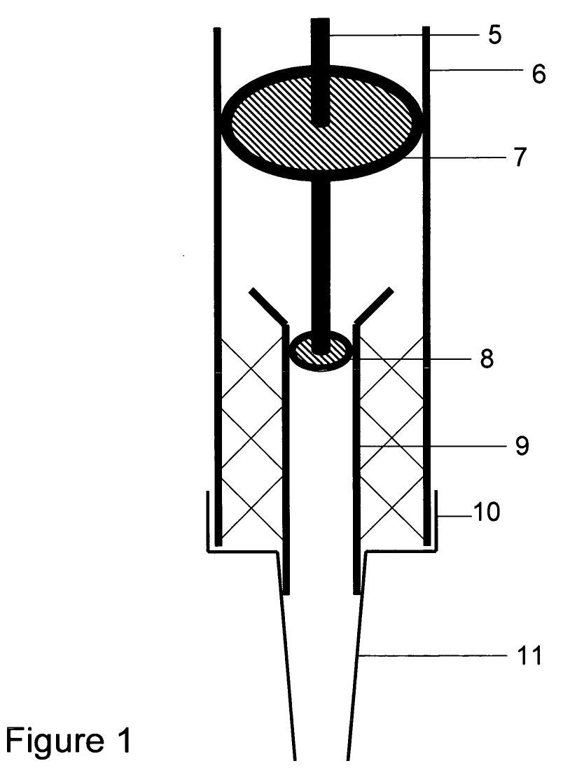

With reference to FIG. 1, one plunger (5) connects to all pistons (7&8) so that they move in unison when the plunger is depressed or released. The pistons (7&8) are made to fit the corresponding cylinders (6&9). Cylinders' cross sectional areas vary according to the pipetting range. These areas are proportional to each others by the same ratio between different ranges. For example, the cross sectional area on a 0-100 ul range is 10 times the cross sectional area of a 0-10 ul range or is equal to 0.1 time the cross sectional area of a 0-1000 ul range when these ranges are incorporated in the same pipette.

With reference to FIG. 1, one ejection mechanism can be used for all snap-on tip sizes when the smaller sized tip (11) comes with a sleeve (10) that extend upward and loosely fit outside the biggest cylinder. The sleeve will also provide additional protection against contamination by shielding the large cylinder from contacting medium or container wall. With the exception of the largest tip for use with this type of pipette, all smaller sizes tips require the sleeve for the ejection mechanism to exert it force upon for tip ejection.

Other ejection mechanisms are also possible; however, they may be too cumbersome and may add significant cost to the product. One design uses a special ejector that constricts as it move downward thus is capable of ejecting different size tips. Another mechanism uses the outer barrel as the ejector for the immediate inner barrel. These designs are known to those skilled in the art and are too numerous to described.

The pistons, cylinders, and dialing mechanisms for adjusting volume are the same as existing pipettes on the markets. The making and assembly of these mechanisms are known to those skilled in the art and are also described in prior arts such as U.S. Pat. Nos. 3,754,687, 5,970,806 and U.S. patent publication 2003074988; or can be studied from existing pipettes.

1. A pipette comprises of at least two different cylinders for dispensing fluid at two different ranges.

2. The pipette of claim 1 wherein one cylinder is partially enclosed within another cylinder.

3. The pipette of claim 1 wherein one cylinder is adjacent to another cylinder.

4. The pipette of claim 1 wherein said different ranges are selected by choosing the corresponding disposable pipette tip.

5. A pipette capable of delivering volumes within at least two different ranges.

6. The pipette of claim 5 wherein a unique disposable tips is used for each of said different ranges.

7. The pipette of claim 5 wherein each of said different ranges cover one order of magnitude.

8. The pipette of claim 5 further comprising:
(a) two different set of cylinders; and
(b) two different sets of pistons.

9. A pipette tip containing an extended sleeve loosely fit a bigger cylinder in a multi-range pipette to enable ejection of said pipette tip.

10. The pipette tip of claim 10 wherein said extended sleeve further serves as a barrier against contamination.
